(19) United States
(12) Patent Application Publication
(10) Pub. No.: US 2026/0137576 A1
(43) Pub. Date: May 21, 2026

(54) CKC SPINAL REHABILITATION EXERCISE DEVICE

(71) Applicant: PhysioRobotics Co., Ltd., Changwon-si (KR)

(72) Inventor: Seong Yeol KIM, Changwon-si (KR)

(21) Appl. No.: 19/359,897

(22) Filed: Oct. 16, 2025

(30) Foreign Application Priority Data
Nov. 19, 2024 (KR) 10-2024-0164741
Sep. 11, 2025 (KR) 10-2025-0129719

(51) Int. Cl. A61H 1/00

(52) U.S. Cl. CPC A61H 1/006; A61H 2201/1253; A61H 2201/163; A61H 2201/1638; A61H 2201/1642; A61H 2203/0425; A61H 2205/081; A61H 2205/088

(57) ABSTRACT

Provided is a spinal rehabilitation exercise device that provides various driving patterns to allow correction optimized for different body types and spinal conditions of spinal patients to be performed. A spinal rehabilitation exercise device according to one aspect of the present invention includes a body, an extension part configured to extend from the body, a handle part provided on the extension part and configured to move along the extension part or rotate relative to the extension part according to manipulation by a user, and a spinal correction part provided on the body and configured to press a spinal region of the user while the user is seated thereon. In addition, a closed kinetic chain (CKC) spinal rehabilitation exercise device according to another embodiment of the present invention includes a main body part forming an exterior, arm support parts connected to an upper side of the main body part and supporting the arms of a user, a pelvic correction part provided on a lower side of the main body part and provided so that the user is able to sit thereon, a torso support part disposed apart from the pelvic correction part on the main body part and provided to support the torso of the user, foot support parts connected to the main body part, provided to be movable, and provided to support the feet of the user, and a monitor part disposed apart from the torso support part on the main body part and provided to allow the user to check body information. In this way, the user is able to perform a rehabilitation exercise while checking his or her body activity.

### CROSS-REFERENCE TO RELATED APPLICATION

This application claims priority to and the benefit of Korean Patent Applications No. 10-2024-0164741, filed on November 19, 2024, and No. 10-2025-0129719, filed on September 11, 2025. The entire disclosures of all these applications are hereby incorporated by reference.

### BACKGROUND

### 1. Field of the Invention

The present invention relates to a closed kinetic chain (CKC) spinal rehabilitation exercise device, and more particularly, to a device for achieving spinal stabilization and improving spinal balance by providing various driving patterns and being optimized for different body types and spinal conditions of spinal patients to allow an exercise of moving muscles and joints while a part of the body is in contact with a fixed point to be efficiently performed to strengthen the spine and peripheral muscles and improve stability.

### 2. Discussion of Related Art

For humans who walk upright, it is an unavoidable reality that a large load is placed on the spine, and in general, individual body structures or living habits may lead to pelvic imbalance in everyday life, resulting in a slight difference in length between the left and right legs. This can lead to lumbar pain and sciatica and even increase the risk of disc herniation due to the spine being misaligned. Disc herniation is emerging as a more serious problem due to modern people’s lack of exercise and, especially, increased sedentary lifestyles.

Scoliosis refers to a sideways curvature of the spine from the central axis when viewed from the front, but in reality, it is not a simple two-dimensional deformation, but a three-dimensional deformation in which the normal curvature is lost even when viewed from the side due to rotational deformation of the vertebral bodies. Idiopathic scoliosis, the cause of which is not clearly known despite various domestic and international studies, accounts for approximately 85% of all scoliosis cases, is particularly prevalent during adolescence, commonly appears between the age of 10 and the time of completion of growth, and rapidly develops between the ages of 12 and 16 (Gunnoe, 1990), scoliosis among adolescents in Korea continues to increase, and its seriousness has been widely reported and is being recognized as a social issue.

In addition, scoliosis is known to cause abnormal curvature of the spine, causing tension in the muscles and ligaments around the spine, and cause compression of the nerves, causing symptoms including cosmetic and functional defects and emotional disorders such as headaches, pain in the neck, shoulders, and lower back, a frequent feeling of fatigue, and chronic fatigue.

The domestic and international treatment and research trends for scoliosis so far include nonsurgical treatments such as manual correction therapy by a professional therapist, brace treatment, and a deep spinal muscle-strengthening exercise accompanied by a breathing exercise such as the Schroth method.

Brace treatment, which is a nonsurgical treatment, not only takes a long time, but also has minimal treatment effects compared to the cost, and patients’ satisfaction with the treatment is low due to discomfort in wearing the brace and an undesirable appearance. In addition, manual correction therapy may be partially effective for mild to moderate functional scoliosis, but its effectiveness is limited for patients with idiopathic scoliosis, and the correction effect is minimal, especially in adults. Further, performing correction can be very difficult for inexperienced therapists. Furthermore, efficiency of the correction therapy is low because it is applied while the spinal segments are not fixed, and most medical apparatuses used for the correction therapy are expensive imported apparatuses. In addition, surgical treatment can only be performed when the degree of angular deformity is sufficiently high to apply surgery and requires high medical expenses and a long rehabilitation period, and thus efficiency of surgical treatment is also low.

Meanwhile, the Schroth method, which is a nonsurgical exercise method widely used to treat idiopathic scoliosis, is a customized spinal correction exercise using a closed kinetic chain (CKC) exercise with a breathing exercise to correct the three-dimensionally twisted spine and is recommended as a nonsurgical treatment method for patients with idiopathic scoliosis worldwide.

However, to maximize the effectiveness of the Schroth method, it should be performed by a skilled professional therapist who has completed extensive training, and a long treatment period and high treatment costs of the Schroth method may cause a financial burden on patients and their caretakers.

Therefore, there is an urgent need for development of a new fused exercise rehabilitation device that can maximize a scoliosis correction treatment effect while lowering medical expenses.

### SUMMARY OF THE INVENTION

The present invention is directed to providing a spinal rehabilitation exercise device that provides various driving patterns to allow correction optimized for different body types and spinal conditions of spinal patients to be performed.

Embodiments of the present invention are directed to providing a closed kinetic chain (CKC) rehabilitation exercise device that allows support positions of the arms, torso, pelvis, knees, and feet to be independently adjusted according to the body type and rehabilitation stage of a user.

Embodiments of the present invention are directed to providing a CKC rehabilitation exercise device that can induce organic movement of the trunk and limbs while fixing the hands and feet according to a CKC exercise method.

Embodiments of the present invention are directed to providing a CKC rehabilitation exercise device that can implement various postures by each support part being movable in various directions such as an up-down direction, a front-rear direction, and a rotating direction.

Embodiments of the present invention are directed to providing a CKC rehabilitation exercise device that can provide user-centered feedback by providing exercise information and the state of the body through a plurality of monitors in real time.

Embodiments of the present invention are directed to providing a CKC rehabilitation exercise device that can improve precision and convenience of a rehabilitation exercise by coupling a power part to each support part and automatically or semi-automatically adjusting a posture.

However, objectives of the present invention are not limited to those mentioned above, and other unmentioned objectives should be clearly understood by those of ordinary skill in the art based on the following description of the invention.

According to one aspect of the present invention, there is provided a spinal rehabilitation exercise device including a body, an extension part configured to extend from the body, a handle part provided on the extension part and configured to move along the extension part or rotate relative to the extension part according to manipulation by a user, and a spinal correction part provided on the body and configured to press a spinal region of the user while the user is seated thereon.

Preferably, the extension part may be configured to be pivoted at a predetermined angle relative to the body.

Preferably, the extension part may include a front extension part located on a front side of the spinal correction part and a pair of side extension parts located on both sides of the spinal correction part, and when viewed on a horizontal plane, an angle that the pair of side extension parts form based on an area where the front extension part is located may be less than 180°.

Preferably, the handle part may include a first handle located on the extension part and on the front side of the spinal correction part and second handles located on the extension part and on both sides of the spinal correction part, the first handle may be configured to move along the extension part located on the front side of the spinal correction part or rotate relative to the extension part due to manipulation by the user while the user is seated on the spinal correction part, and the second handles may be configured to move along the extension parts located on both sides of the spinal correction part or rotate relative to the extension parts due to manipulation by the user while the user is seated on the spinal correction part.

Preferably, the spinal correction part may include a seating part that is position-changeable in an up-down direction and configured to rotate relative to the body through a base part and a pelvic fixation part provided on the seating part and configured to fix the pelvis of the user.

Preferably, the spinal correction part may further include first spine pressing parts disposed on both sides of the spinal region of the user and configured to press both sides of the spinal region of the user.

Preferably, the first spine pressing parts may each include a first pressing driving part configured to be driven toward a side surface of the spinal region of the user and press the side surface of the spinal region of the user and a first up-down driving part configured to change a position of the first pressing driving part in an up-down direction and configured to rotate along the base part.

Preferably, the spinal correction part may further include a second spine pressing part disposed on a rear surface of the spinal region of the user and configured to press the rear surface of the spinal region of the user.

Preferably, the second spine pressing part may include a second pressing driving part configured to be driven toward the rear surface of the spinal region of the user and press the rear surface of the spinal region of the user and a second up-down driving part configured to change a position of the second pressing driving part in the up-down direction.

According to another aspect of the present invention, there is provided a closed kinetic chain (CKC) spinal rehabilitation exercise device including a main body part forming an exterior, arm support parts connected to an upper side of the main body part and supporting the arms of a user, a pelvic correction part provided on a lower side of the main body part and provided so that the user is able to sit thereon, a torso support part disposed apart from the pelvic correction part on the main body part and provided to support the torso of the user, foot support parts connected to the main body part, provided to be movable, and provided to support the feet of the user, and a monitor part disposed apart from the torso support part on the main body part and provided to allow the user to check body information.

Preferably, the CKC spinal rehabilitation exercise device may further include handle parts provided on the arm support parts and provided to be gripped by the user and knee support parts provided on the pelvic correction part to support the knees of the user, and the main body part may include a torso foundation part that has an upper side on which the pelvic correction part and the torso support part are disposed and that is provided so that at least a portion thereof is rotatable.

Preferably, the main body part may be provided to be movable in an up-down direction, the arm support parts may be provided to be rotatable to move away from or approach the pelvic correction part, the handle parts may be provided to be movable to move away from or approach the pelvic correction part, the torso support part may be movable in the up-down direction and provided to be movable to move away from or approach the pelvic correction part, and the foot support parts may be movable to move away from or approach the pelvic correction part and may have at least a portion provided to be movable in the up-down direction.

Preferably, the main body part may further include a main body frame part forming an exterior and a main body moving part that is connected to the main body frame part, extends to be curved, and is provided to be movable in the up-down direction, the arm support parts may each include an arm support pivoting part connected to an end of the main body moving part and provided to be pivotable and an arm support main body part extending in a curved manner from the arm support pivoting part, the handle parts may each include an upper handle part provided on the arm support main body part, a lower handle part disposed apart from the upper handle part to be provided closer to the pelvic correction part than the upper handle part on the arm support main body part, an upper power part that connects the upper handle part and the arm support main body part and is provided to move the upper handle part, and a lower power part that connects the lower handle part and the arm support main body part and is provided to move the lower handle part, the pelvic correction part may include a pelvic correction connecting part placed on the torso foundation part, a pelvic one side placing part provided on the pelvic correction connecting part and on which one side of the pelvis of the user is placed, and a pelvic other side placing part disposed apart from the pelvic one side placing part on the pelvic correction connecting part and on which the other side of the pelvis of the user is placed, and the pelvic one side placing part and the pelvic other side placing part may be provided to be independently movable in the up-down direction.

Preferably, the torso foundation part may include a torso lower foundation part connected to the main body frame part and placed on a floor and a torso upper foundation part disposed on an upper side of the torso lower foundation part and provided to be rotatable, the torso support part may include a torso upper support part disposed on the upper side of the torso lower foundation part and provided to be rotatable along a circumference of the torso upper foundation part and a torso lower support part that is disposed at the torso upper foundation part and rotatable according to rotation of the torso upper foundation part, the torso upper support part may include an upper support main body part forming an exterior, an upper support rotating part that connects the upper support main body part and the torso upper foundation part and rotates independently from the rotation of the torso upper foundation part, an upper support moving part connected to the upper support main body part and provided to be movable in the up-down direction, and an upper support pressing part disposed on an end of the upper support moving part and provided to approach or move away from the pelvic correction part, and the torso lower support part may include a lower support main body part forming an exterior and placed on the torso upper foundation part, a lower support moving part connected to the lower support main body part and provided to be movable in the up-down direction, and a lower support pressing part disposed on an end of the lower support moving part and provided to approach or move away from the pelvic correction part.

Preferably, the torso upper support part may include torso upper front and rear support parts disposed at a front and rear of the torso lower foundation part and torso upper side support parts disposed on both sides of the torso lower foundation part and disposed apart from the torso upper front and rear support parts, the torso lower support part may include torso lower rear support parts disposed at a rear of the torso upper foundation part and disposed to face the knee support parts and torso lower side support parts disposed on both sides of the torso upper foundation part and disposed apart from the torso lower rear support parts, the upper support pressing part of each of the torso upper side support parts may be formed to be more curved than the upper support pressing part of each of the torso upper front and rear support parts, and the lower support pressing part of each of the torso lower side support parts may be formed to be more curved than the lower support pressing part of each of the torso lower rear support parts.

Preferably, the foot support parts may each include a foot support main body part forming an exterior, a foot support path part that is connected to the torso lower foundation part and provides a path along which the foot support main body part is moved, and a foot support placing part disposed on an inner side of the foot support main body part and provided to be movable in the up-down direction.

Preferably, the knee support parts may each include a knee support moving part connected to the pelvic correction part and provided to be movable forward and rearward, a knee support main body part having one end coupled to an end of the knee support moving part, and a knee support performing part that is coupled to the other end of the knee support main body part, is movable in the up-down direction, and is provided to be pivotable to support a knee of the user.

Preferably, the monitor part may include a first monitor part provided on one side of the main body frame part to provide first information and a second monitor part provided on the other side of the main body frame part to provide second information.

### BRIEF DESCRIPTION OF THE DRAWINGS

The following drawings accompanied herein illustrate preferable embodiments of the present invention, and serve to further facilitate understanding of the technical idea of the present invention together with the detailed description of the invention given below, and thus the present invention should not be construed as being limited to the matters shown in such drawings.

FIGS. 1 to 4 are views illustrating a spinal rehabilitation exercise device according to one embodiment of the present invention.

FIGS. 5 and 6 are views illustrating a handle part provided in the spinal rehabilitation exercise device of FIG. 1 in detail.

FIGS. 7 and 8 are views illustrating a spinal correction part provided in the spinal rehabilitation exercise device of FIG. 1.

FIG. 9(a) and FIG. 9(b) are a perspective view of a closed kinetic chain (CKC) spinal rehabilitation exercise device according to one embodiment of the present invention.

FIG. 10 is a front view of the CKC spinal rehabilitation exercise device according to another embodiment of the present invention.

FIG. 11(a) and FIG. 11(b) are a view illustrating an operation of a main body part of the CKC spinal rehabilitation exercise device according to another embodiment of the present invention.

FIG. 12(a) and FIG. 12(b) are a view illustrating an operation of arm support parts of the CKC spinal rehabilitation exercise device according to another embodiment of the present invention.

FIG. 13(a) and FIG. 13(b) are a view illustrating an operation of handle parts of the CKC spinal rehabilitation exercise device according to another embodiment of the present invention.

FIG. 14(a) and FIG. 14(b) are a view illustrating a vertical operation of a torso support part of the CKC spinal rehabilitation exercise device according to another embodiment of the present invention.

FIG. 15(a), FIG. 15(b), FIG. 15(c), FIG. 15(d) are a view illustrating a horizontal operation of the torso support part of the CKC spinal rehabilitation exercise device according to another embodiment of the present invention.

FIG. 16(a), FIG. 16(b), FIG. 16(c) are a view illustrating a rotating operation of a torso lower support part of the CKC spinal rehabilitation exercise device according to another embodiment of the present invention.

FIG. 17(a), FIG. 17(b) are a view illustrating a rotating operation of a torso upper support part of the CKC spinal rehabilitation exercise device according to another embodiment of the present invention.

FIG. 18(a), FIG. 18(b) are a view illustrating a horizontal operation of a foot support part of the CKC spinal rehabilitation exercise device according to another embodiment of the present invention.

FIG. 19(a), FIG. 19(b) are a view illustrating a vertical operation of the foot support part of the CKC spinal rehabilitation exercise device according to another embodiment of the present invention.

FIG. 20(a), FIG. 20(b), FIG. 20(c) are a view illustrating an operation of a pelvic correction part of the CKC spinal rehabilitation exercise device according to another embodiment of the present invention.

FIG. 21(a), FIG. 21(b), FIG. 21(c), FIG. 21(d) are a view illustrating an operation of a knee support part of the CKC spinal rehabilitation exercise device according to another embodiment of the present invention.

FIG. 22(a), FIG. 22(b) are a view illustrating a rotating operation of the foot support part of the CKC spinal rehabilitation exercise device according to another embodiment of the present invention.

### DETAILED DESCRIPTION OF EXEMPLARY EMBODIMENTS

Hereinafter, exemplary embodiments of the present invention will be described in detail with reference to the accompanying drawings. Terms or words used in this specification and the claims should not be interpreted as being limited to their general or dictionary meanings and should be interpreted as having meanings and concepts consistent with the technical idea of the present invention based on the principle that the inventor can appropriately define the concepts of the terms in order to best explain his or her invention.

Therefore, since the embodiments described in this specification and the configurations illustrated in the drawings are only some of the most preferred embodiments of the present invention and do not represent all of the technical idea of the present invention, it should be understood that there may be various equivalents and modifications that can replace them at the time of filing this application.

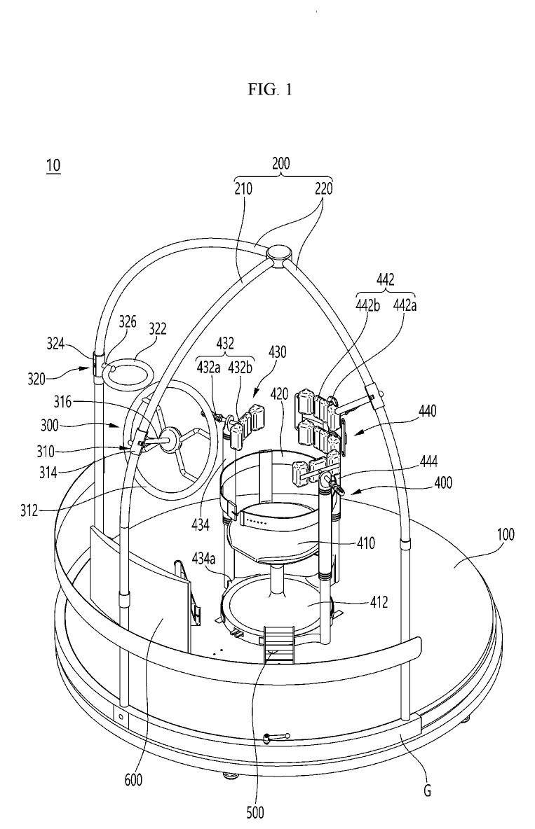

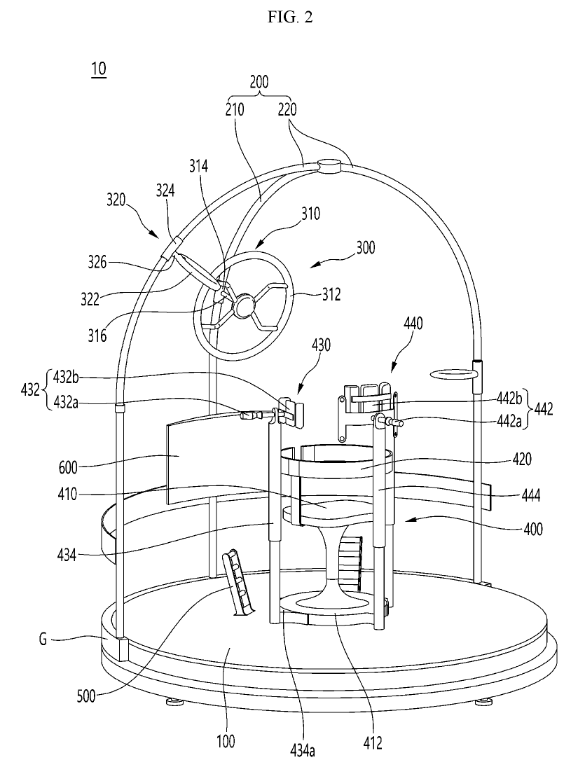

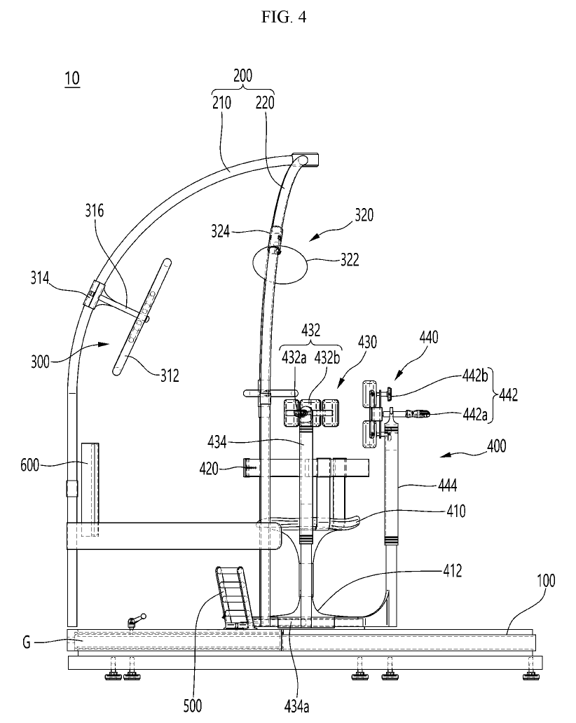

FIGS. 1 to 4 are views illustrating a spinal rehabilitation exercise device 10 according to one embodiment of the present invention.

Referring to FIGS. 1 to 4, the spinal rehabilitation exercise device 10 according to one embodiment of the present invention may include a body 100, an extension part 200, a handle part 300, and a spinal correction part 400. The spinal rehabilitation exercise device 10 may be a medical device for treating scoliosis of a user.

The body 100 may constitute an exterior of the spinal rehabilitation exercise device 10. In one embodiment, the body 100 may be formed in the shape of a disc having a predetermined thickness.

The extension part 200 may be configured to be perpendicular to the body 100. The extension part 200 may have a portion configured in a curved shape to be provided in a shape that can be easily gripped by the user.

The handle part 300 may be provided on the extension part 200 and configured to move along the extension part 200 or rotate relative to the extension part 200 according to manipulation by the user. The handle part 300 may be provided in a shape that can be easily gripped by the user. Meanwhile, the configuration in which the handle part 300 moves along the extension part 200 or rotates relative to the extension part 200 according to manipulation by the user will be described in detail below in the relevant description.

The spinal correction part 400 may be provided on the body 100 and configured to press a spinal region of the user while the user is seated thereon. That is, the spinal correction part 400 may press the spinal region of the user while supporting the spinal region of the user. A detailed configuration of the spinal correction part 400 will be described in detail below in the relevant description.

That is, in an embodiment of the present invention, scoliosis correction can be performed by a pushing force or a pulling force being imparted to the spinal region when the user grips the handle part 300 by hand and pulls the handle part 300 in a state in which the user is seated on the spinal correction part 400 and the lower body of the user is fixed. In particular, in an embodiment of the present invention, for the pushing force or the pulling force to be further imparted to a region where the degree of curvature of the spine is severe compared to a normal state among both sides of the spinal region of the user, the handle part 300 may be configured to be movable along the extension part 200 and configured to be rotatable relative to the extension part 200 in the state in which the user is seated on the spinal correction part 400, and the position of the handle part 300 relative to the spinal region of the user can be easily adjusted. Accordingly, by the pushing force or the pulling force being further imparted to the region where the degree of curvature of the spine is severe compared to the normal state among both sides of the spinal region of the user, the scoliosis correction effect can be further maximized.

That is, by the spinal rehabilitation exercise device 10 of the present invention providing various driving patterns for strengthening the spine of the user, correction optimized for different body types and spinal conditions of spinal patients can be easily performed.

In addition, the spinal rehabilitation exercise device 10 of the present invention may further include a footrest part 500 and a display part 600.

The footrest part 500 may be provided on a front side of the spinal correction part 400, may be provided on the body 100, and may be formed in a shape on which a foot of the user can be placed.

The display part 600 may display a state in which scoliosis of the user is corrected by the spinal rehabilitation exercise device 10 to the user in real time.

In one embodiment, the extension part 200 may be configured to be pivoted at a predetermined angle relative to the body 100. Specifically, the extension part 200 may be pivoted at a predetermined angle (for example, 360°) relative to the body 100 as an extension part pivoting guide part G provided on a lower end of the extension part 200 is rotated in the circumferential direction of the body 100.

In this way, since the extension part 200 may be rotatable when the user grips the handle part 300 by hand and pulls the handle part 300 while the user is seated on the spinal correction part 400 and the lower body of the user is fixed, the pushing force or the pulling force can be imparted to the spinal region of the user in more diverse directions. Accordingly, correction that is further optimized for the body type and spinal condition of a spinal patient can be performed.

Referring back to FIGS. 1 to 4, the extension part 200 may include a front extension part 210 and a pair of side extension parts 220.

The front extension part 210 may be located on the front side of the spinal correction part 400. The front extension part 210 may be configured to extend perpendicular to the body 100 and may have an upper portion configured in a curved shape.

The pair of side extension parts 220 may be located on both sides of the spinal correction part 400. The pair of side extension parts 220 may be configured to extend perpendicular to the body 100 and may have an upper portion configured in a curved shape. In addition, an upper end of the front extension part 210 and upper ends of the pair of side extension parts 220 may be connected to one another (see FIGS. 1 to 4).

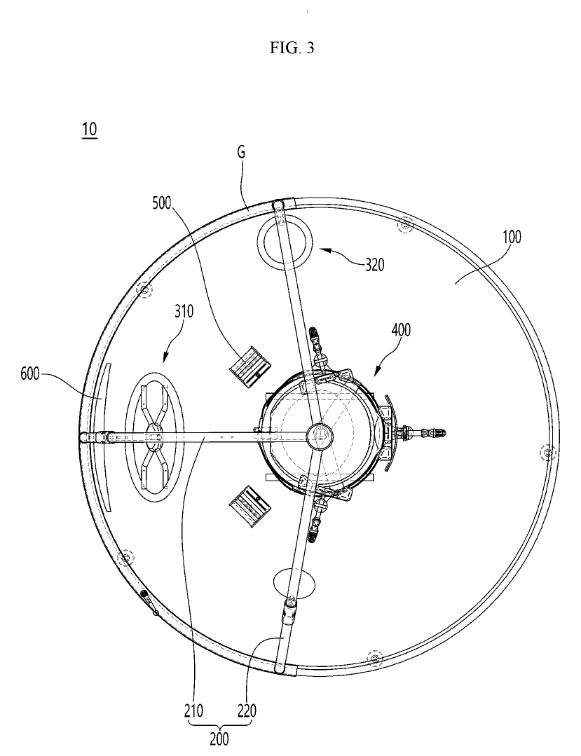

In one embodiment, when viewed on a horizontal plane of the body 100, an angle that the pair of side extension parts 220 form based on an area where the front extension part 210 is located may be less than 180° (see FIG. 3). Due to such a configuration, when the user grips the handle part 300 by hand and pulls the handle part 300 while the user is seated on the spinal correction part 400, an angle that both shoulders of the user form may be guided to be less than 180° to correspond to the angle that the pair of side extension parts 220 form. Accordingly, by the pushing force being imparted to spinal regions at both sides of the user, the scoliosis correction effect can be further maximized.

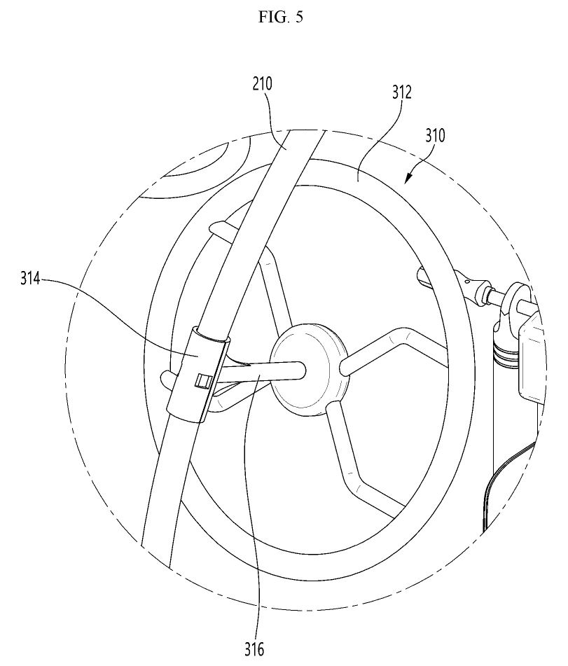

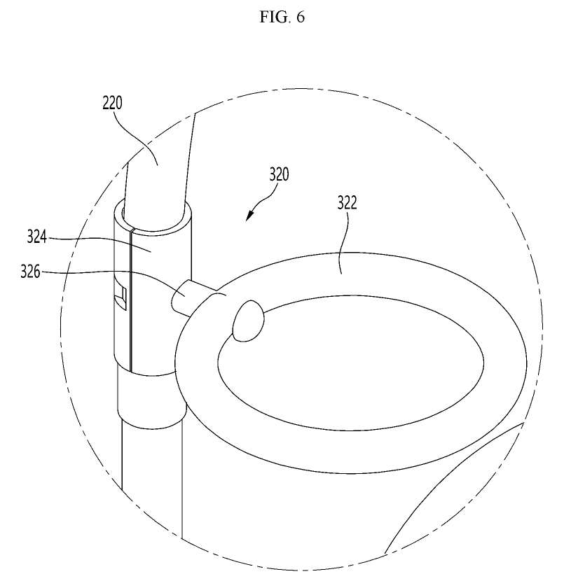

FIGS. 5 and 6 are views illustrating the handle part 300 provided in the spinal rehabilitation exercise device 10 of FIG. 1 in detail.

Referring to FIGS. 1 to 6, the handle part 300 may include a first handle 310 and second handles 320.

The first handle 310 may be located on the extension part 200 and on the front side of the spinal correction part 400. Specifically, the first handle 310 may be provided on the front extension part 210 described above.

The second handles 320 may be located on the extension part 200 and on both sides of the spinal correction part 400. Specifically, the second handles 320 may be provided as a pair of second handles 320 on the pair of side extension parts 220 described above.

In one embodiment, the first handle 310 may be configured to move along the extension part 200 located on the front side of the spinal correction part 400 or rotate relative to the extension part 200 due to manipulation by the user while the user is seated on the spinal correction part 400.

Specifically, the first handle 310 may include a first gripping part 312, a first handle movement guide part 314, and a first handle pivoting guide part 316.

The first gripping part 312 may be provided in a shape that can be gripped by a hand of the user.

The first handle movement guide part 314 may be configured to be inserted into the front extension part 210 and guide movement of the first gripping part 312 along the front extension part 210.

The first handle pivoting guide part 316 may have one end axially coupled to the first handle movement guide part 314 and the other end coupled to the first gripping part 312. In addition, the first handle pivoting guide part 316 may be pivoted when a force is applied to the first gripping part 312 and may rotate the first gripping part 312 relative to the front extension part 210.

In addition, the second handles 320 may be configured to move along the extension part 200 located on both sides of the spinal correction part 400 or rotate relative to the extension part 200 due to manipulation by the user while the user is seated on the spinal correction part 400.

Specifically, the second handles 320 may each include a second gripping part 322, a second handle movement guide part 324, and a second handle pivoting guide part 326.

The second gripping part 322 may be provided in a shape that can be gripped by a hand of the user.

The second handle movement guide part 324 may be configured to be inserted into one of the pair of side extension parts 220 and guide movement of the second gripping part 322 along the side extension part 220.

The second handle pivoting guide part 326 may have one end axially coupled to the second handle movement guide part 324 and the other end coupled to the second gripping part 322. In addition, the second handle pivoting guide part 326 may be pivoted when a force is applied to the second gripping part 322 and may rotate the second gripping part 322 relative to the side extension part 220.

That is, in an embodiment of the present invention, for the pushing force or the pulling force to be further imparted to a region where the degree of curvature of the spine is severe compared to a normal state among both sides of the spinal region of the user, the handle part 300 may be configured to be movable along the front extension part 210 and/or the side extension parts 220 and configured to be rotatable relative to the front extension part 210 and/or the side extension parts 220 in the state in which the user is seated on the spinal correction part 400, and the position of the handle part 300 relative to the spinal region of the user can be easily adjusted. Accordingly, by the pushing force or the pulling force being easily imparted to the region where the degree of curvature of the spine is severe compared to the normal state among both sides of the spinal region of the user, the scoliosis correction effect can be further maximized.

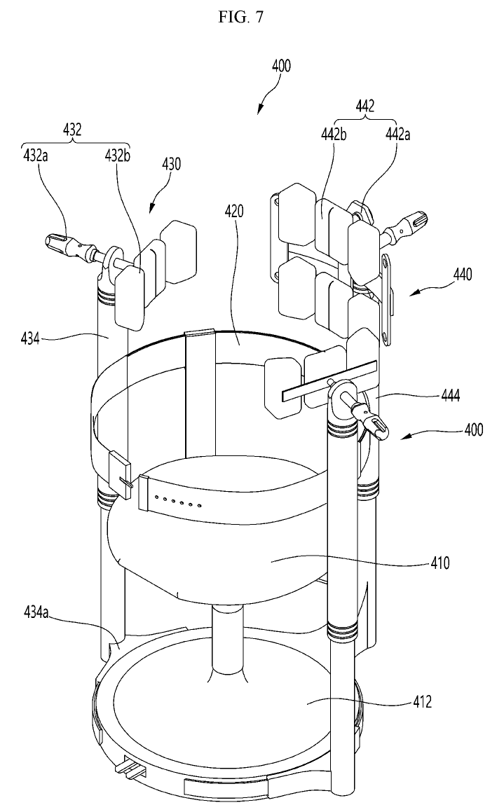

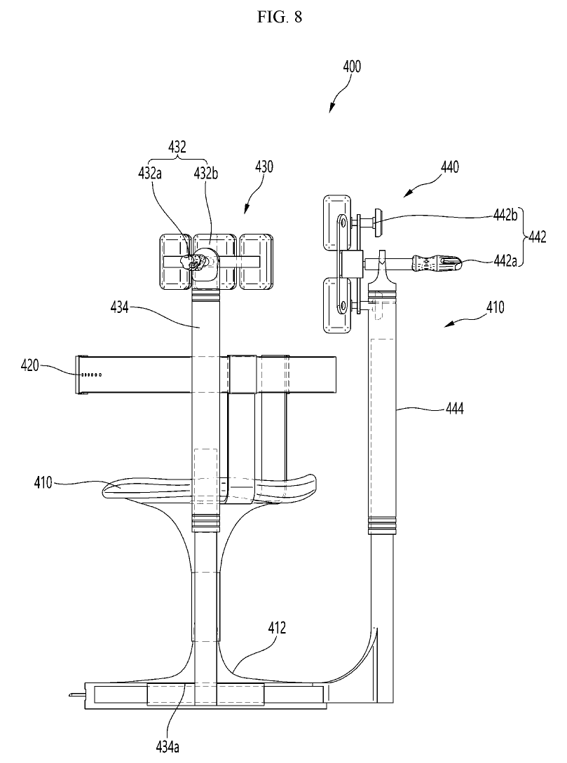

FIGS. 7 and 8 are views illustrating the spinal correction part 400 provided in the spinal rehabilitation exercise device 10 of FIG. 1.

Referring to FIGS. 7 and 8, the spinal correction part 400 may include a seating part 410 and a pelvic fixation part 420.

The seating part 410 may be position-changeable in an up-down direction. Accordingly, the position of the spinal region of the user in the up-down direction can be adjusted relative to the extension part 200 and the handle part 300 while the user is seated on the seating part 410. In one embodiment, the seating part 410 may be configured so that the position thereof is able to be changed in the up-down direction through an actuator (not illustrated), but the present invention is not limited thereto.

In addition, the seating part 410 may be configured to rotate relative to the body 100 through a base part 412 at a lower end. Accordingly, the position of the spinal region of the user in the circumferential direction of the body 100 can be adjusted relative to the extension part 200 and the handle part 300 while the user is seated on the seating part 410. In one embodiment, the base part 412 may be configured to be rotatable relative to the body 100 through a separate rotary motor (not illustrated), but the present invention is not limited thereto.

The pelvic fixation part 420 is provided on the seating part 410 and configured to fix the pelvis of the user. Accordingly, the spinal region and the lower body region of the user can be stably fixed when the user grips the handle part 300 by hand and pulls the handle part 300 while the user is seated on the seating part 410.

With such a configuration, since the position of the spinal region of the user in the up-down direction relative to the extension part 200 and the handle part 300 and/or the position of the spinal region of the user in the circumferential direction of the body 100 relative to the extension part 200 and the handle part 300 can be adjusted while the user is seated on the spinal correction part 400, the pushing force or the pulling force can be imparted to the spinal region of the user in more diverse directions. Accordingly, correction that is further optimized for the body type and spinal condition of a spinal patient can be performed.

In one embodiment, the spinal correction part 400 may further include first spine pressing parts 430.

The first spine pressing parts 430 may be disposed on both sides of the spinal region of the user and configured to press both sides of the spinal region of the user. That is, the first spine pressing parts 430 may be provided as a pair.

Specifically, the first spine pressing parts 430 may each include a first pressing driving part 432 and a first up-down driving part 434.

The first pressing driving part 432 may be configured to be driven toward a side surface of the spinal region of the user and press the side surface of the spinal region of the user.

In one embodiment, the first pressing driving part 432 may include a first moving part 432a and a first pressing part 432b.

The first moving part 432a may be configured to be driven toward the side surface of the spinal region of the user. In one embodiment, the first moving part 432a may be an actuator (not illustrated) but is not limited thereto.

The first pressing part 432b may be provided on one end of the first moving part 432a. In addition, the first pressing part 432b may press the side surface of the spinal region of the user according to driving of the first moving part 432a. At this time, the first pressing part 432b may be configured to have a predetermined area to easily press the side surface of the spinal region of the user.

The first up-down driving part 434 may be configured to change a position of the first pressing driving part 432 in the up-down direction. In one embodiment, the first up-down driving part 434 may be an actuator (not illustrated) but is not limited thereto. In addition, the first up-down driving part 434 may support the first moving part 432a. Further, the first up-down driving part 434 may be configured to rotate along the base part 412. Specifically, the first up-down driving part 434 may be pivoted at a predetermined angle relative to the base part 412 as a first pressing part pivoting guide part 434a provided on a lower end of the first up-down driving part 434 rotates in the circumferential direction of the base part 412. That is, the first up-down driving part 434 that supports the first pressing driving part 432 may adjust a pressing position of the first pressing driving part 432 in the up-down direction and a pressing position of the first pressing driving part 432 in the circumferential direction of the body 100, relative to the side surface of the spinal region of the user.

In this way, the pressing position in the up-down direction and the pressing position in the circumferential direction of the body 100 relative to the side surface of the spinal region of the user can be adjusted when the user grips the handle part 300 by hand and pulls the handle part 300 while the user is seated on the seating part 410 of the spinal correction part 400 and the lower body of the user is fixed. Accordingly, the pushing force or the pulling force can be imparted to the spinal region of the user in more diverse directions. Accordingly, correction that is further optimized for the body type and spinal condition of a spinal patient can be performed.

Referring back to FIGS. 7 and 8, the spinal correction part 400 may further include a second spine pressing part 440.

The second spine pressing part 440 may be disposed on a rear surface of the spinal region of the user and configured to press the rear surface of the spinal region of the user.

Specifically, the second spine pressing part may include a second pressing driving part 442 and a second up-down driving part 444.

The second pressing driving part 442 may be configured to be driven toward the rear surface of the spinal region of the user and press the rear surface of the spinal region of the user.

In one embodiment, the second pressing driving part 442 may include a second moving part 442a and a second pressing part 442b.

The second moving part 442a may be configured to be driven toward the rear surface of the spinal region of the user. In one embodiment, the second moving part 442a may be an actuator (not illustrated) but is not limited thereto.

The second pressing part 442b may be provided on one end of the second moving part 442a. In addition, the second pressing part 442b may press the rear surface of the spinal region of the user according to driving of the second moving part 442a. At this time, the second pressing part 442b may be configured to have a predetermined area to easily press the rear surface of the spinal region of the user.

The second up-down driving part 444 may be configured to change a position of the second pressing driving part 442 in the up-down direction. In one embodiment, the second up-down driving part 444 may be an actuator (not illustrated) but is not limited thereto. In addition, the second up-down driving part 444 may support the second moving part 442a. That is, the second up-down driving part 444 that supports the second pressing driving part 442 may adjust a pressing position of the second pressing driving part 442 in the up-down direction relative to the rear surface of the spinal region of the user.

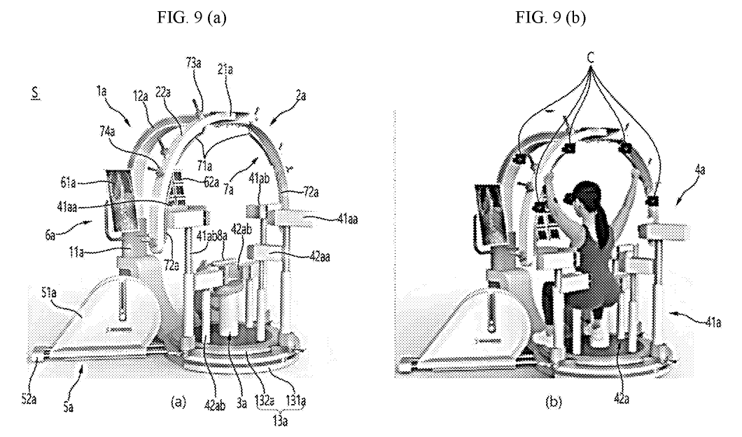

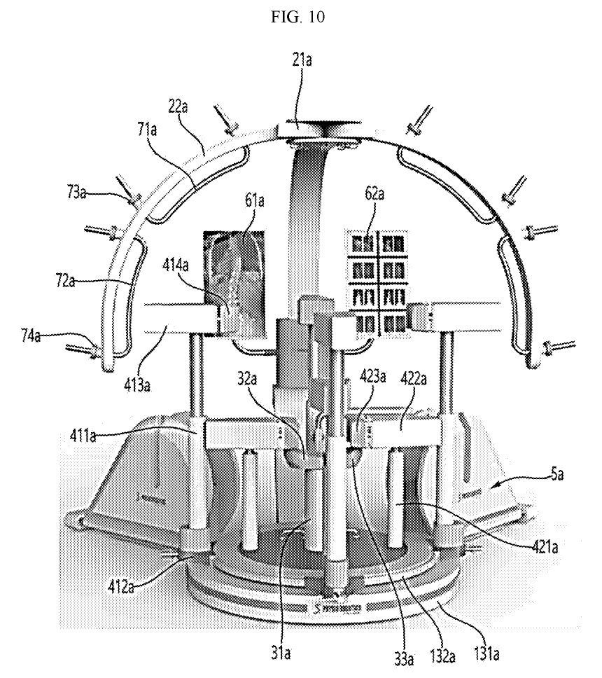

FIG. 9 is a perspective view of a closed kinetic chain (CKC) spinal rehabilitation exercise device according to another embodiment of the present invention. FIG. 10 is a front view of the CKC spinal rehabilitation exercise device according to another embodiment of the present invention.

Referring to FIGS. 9 and 10, a CKC spinal rehabilitation exercise device S according to another embodiment of the present invention may include a main body part 1a, arm support parts 2a, a pelvic correction part 3a, a torso support part 4a, foot support parts 5a, and a monitor part 6a.

The main body part 1a may form an exterior. That is, the main body part 1a may be seated on a floor and fixed and may provide a space in which components such as the arm support parts 2a, the pelvic correction part 3a, the foot support parts 5a, and the monitor part 6a are disposed.

The arm support parts 2a may be connected to an upper side of the main body part 1a and may support the arms of a user. That is, the arm support parts 2a may support the arms of the user when the user is extending the arms while seated on the pelvic correction part 3a to perform a spinal rehabilitation exercise. The user may perform a spinal rehabilitation exercise while the arms are supported by the arm support parts 2a.

In addition, the arm support parts 2a may be provided to be movable while supporting the arms of the user and may facilitate a spinal rehabilitation exercise by relaxing and contracting the arms and other parts of the body according to movement.

The pelvic correction part 3a may be provided on a lower side of the main body part 1a and may be provided so that the user is able to sit thereon. That is, the pelvic correction part 3a may be formed to have a structure that corresponds to the buttocks of the user so that the user is able to sit thereon and may allow the user to perform a spinal rehabilitation exercise while seated. In addition, the pelvic correction part 3a may be provided to be movable while the user is seated thereon and may facilitate a spinal rehabilitation exercise by relaxing and contracting muscles and bones around the pelvis according to movement.

The torso support part 4a may be disposed apart from the pelvic correction part 3a on the main body part 1a and may be provided to support the torso of the user. That is, the torso support part 4a may move in the vertical direction (up-down direction) and the horizontal direction (left-right direction) and may support and press the torso of the user to allow the user to smoothly and effectively perform a rehabilitation exercise.

The foot support parts 5a may be connected to the main body part 1a, may be provided to be movable, and may be provided to support the feet of the user. That is, the positions of the foot support parts 5a may be adjusted to fit the body conditions of a patient to allow the user to smoothly and efficiently perform a rehabilitation exercise.

The monitor part 6a may be disposed apart from the torso support part 4a on the main body part 1a and may be provided to allow the user to check body information. That is, the monitor part 6a may prescribe and provide a patient with an optimized customized exercise program based on input patient information. In addition, the monitor part 6a may provide feedback to the patient based on muscle activity data collected in real time and an image captured by a camera.

Meanwhile, the CKC spinal rehabilitation exercise device S according to another embodiment of the present invention may further include handle parts 7a and knee support parts 8a. The handle parts 7a may be provided on the arm support parts 2a and may be provided to be gripped by the user. That is, the handle parts 7a may allow the user to maintain a stable posture during a spinal rehabilitation exercise and may allow the user to perform a rehabilitation exercise with various postures.

The knee support parts 8a may be provided on the pelvic correction part 3a to support the knees of the user. That is, while the user is unbending one leg, the knee support parts 8a may provide resistance when the user bends the other leg.

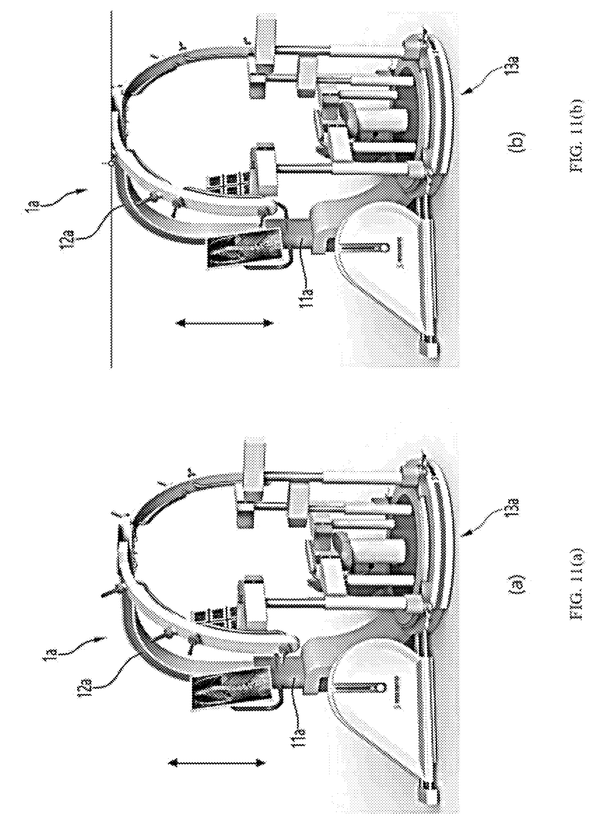

FIG. 11 is a view illustrating an operation of the main body part of the CKC spinal rehabilitation exercise device according to another embodiment of the present invention. Specifically, FIG. 11A illustrates a state in which the main body part is disposed at a first position, and FIG. 11B illustrates a state in which the main body part is moved to a second position that is above the first position.

Referring to FIG. 11, the main body part 1a may be provided to be movable in the up-down direction. That is, the main body part 1a may be height-adjustable, and the position of the main body part 1a may be adjusted to fit the user’s body to allow the user to smoothly perform a rehabilitation exercise.

The arm support parts 2a may be provided to be rotatable to move away from or approach the pelvic correction part 3a. That is, the arm support parts 2a may rotate while supporting the user’s arms to relax or contract the user’s body and allow the user to smoothly perform rehabilitation.

The handle parts 7a may be provided to be movable to move away from or approach the pelvic correction part 3a. That is, since the handle parts 7a can be gripped by the hands of the user and can move away from or approach the pelvic correction part 3a, the handle parts 7a may contract or relax the user’s body and allow the user to efficiently perform a spinal rehabilitation exercise.

The torso support part 4a may be movable in the up-down direction and may be provided to be movable to move away from or approach the pelvic correction part 3a. That is, the torso support part 4a may be movable in the vertical direction and the horizontal direction and may support and press the torso of the user to allow the user to smoothly perform rehabilitation.

The foot support parts 5a may be movable to move away from or approach the pelvic correction part 3a and may have at least a portion provided to be movable in the up-down direction. That is, the positions of the foot support parts 5a may be adjusted to fit the user’s body, and the foot support parts 5a may provide an external force necessary for a spinal rehabilitation exercise by changing the positions of the user’s feet.

Meanwhile, the main body part 1a may include a main body frame part 11a, a main body moving part 12a, and a torso foundation part 13a. The main body frame part 11a may form an exterior. That is, the main body frame part 11a may extend in the up-down direction and form a frame.

The main body moving part 12a may be connected to the main body frame part 11a, may extend to be curved, and may be provided to be movable in the up-down direction. That is, the main body moving part 12a may efficiently provide various conditions necessary for rehabilitation of the user by moving in the up-down direction while the arm support parts 2a are connected to an end thereof and changing the positions of the arm support parts 2a.

The torso foundation part 13a may have an upper side on which the pelvic correction part 3a and the torso support part 4a are disposed and may be provided so that at least a portion thereof is rotatable. That is, the torso foundation part 13a may provide a rotational force and may allow the user to smoothly perform a spinal rehabilitation exercise through rotary movement.

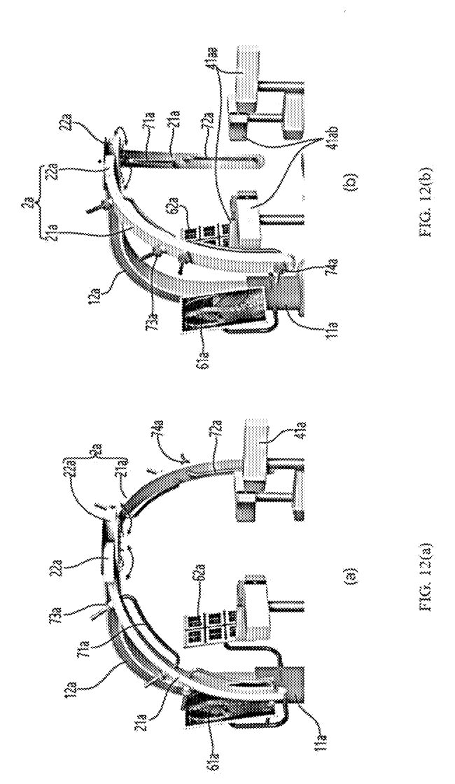

FIG. 12 is a view illustrating an operation of the arm support parts of the CKC spinal rehabilitation exercise device according to another embodiment of the present invention. FIG. 12A illustrates a state in which the arm support part is rotated at a first angle, and FIG. 12B illustrates a state in which the arm support part is rotated at a second angle different from the first angle.

Referring to FIG. 12, the arm support parts 2a may each include an arm support pivoting part 21a and an arm support main body part 22a. The arm support pivoting part 21a may be connected to an end of the main body moving part 12a and may be provided to be pivotable.

The arm support main body part 22a may extend in a curved manner from the arm support pivoting part 21a. That is, the arm support main body part 22a may support an arm of the user and may be provided in a curved shape to enhance convenience in use. In addition, the angle of the arm support main body part 22a may be adjusted according to pivoting of the arm support pivoting part 21a to allow the user to smoothly perform a spinal rehabilitation exercise.

Specifically, the arm support main body part 22a may be provided as a plurality of arm support main body parts 22a to support the left and right arms of the user, and the angle of each arm support main body part 22a may be adjusted up to 120° based on the horizontal plane. Accordingly, the arm support main body parts 22a may stably support the arms and effectively distribute the weight of the user.

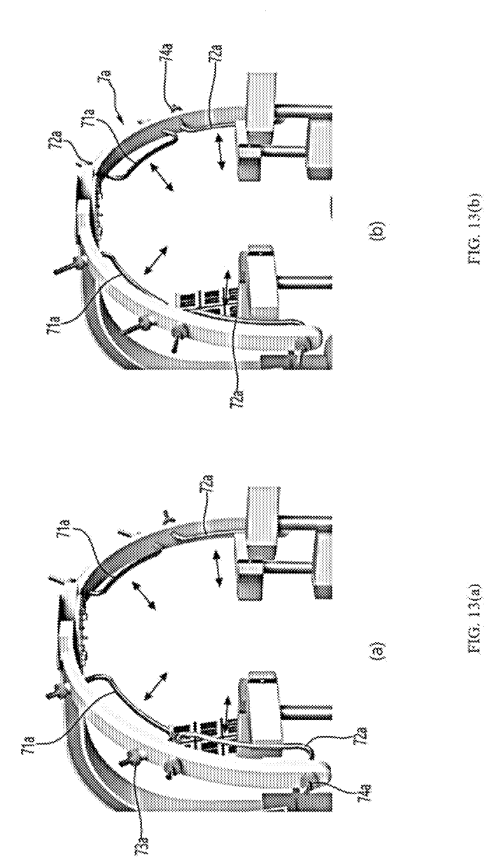

FIG. 13 is a view illustrating an operation of the handle parts of the CKC spinal rehabilitation exercise device according to another embodiment of the present invention. Specifically, FIG. 13A illustrates a state in which the handle part disposed at the left side is moved, and FIG. 13B illustrates a state in which the handle part disposed at the right side is moved.

Referring to FIG. 13, the handle parts 7a may each include an upper handle part 71a, a lower handle part 72a, an upper power part 73a, and a lower power part 74a. The upper handle part 71a may be provided on the arm support main body part 22a. That is, the upper handle part 71a may be disposed relatively above the lower handle part 72a and may provide a space that allows the user to grip the handle part 7a by a hand.

Specifically, the upper handle part 71a may allow a patient to maintain a stable posture during an exercise and may allow a patient to effectively and smoothly perform a spinal rehabilitation exercise by utilizing the functions of the upper limbs.

The lower handle part 72a may be disposed apart from the upper handle part 71a to be provided closer to the pelvic correction part 3a than the upper handle part 71a on the arm support main body part 22a. That is, the lower handle part 72a may be disposed relatively below the upper handle part 71a and may provide a different function from the upper handle part 71a.

Specifically, the lower handle part 72a may be adjusted up to 0.2 m from the coronal plane and may allow a manner in which the user uses the hands and arms to be changed according to the adjustment. Accordingly, a patient can effectively perform a spinal rehabilitation exercise through various movements.

The upper power part 73a may connect the upper handle part 71a and the arm support main body part 22a and may be provided to move the upper handle part 71a. That is, the upper power part 73a may provide power for movement of the upper handle part 71a.

The lower power part 74a may connect the lower handle part 72a and the arm support main body part 22a and may be provided to move the lower handle part 72a. That is, the lower power part 74a may provide power for movement of the lower handle part 72a. In addition, the handle parts 7a may each be disposed on one of the plurality of arm support parts 2a in order to be comfortably gripped by the right and left hands of the user.

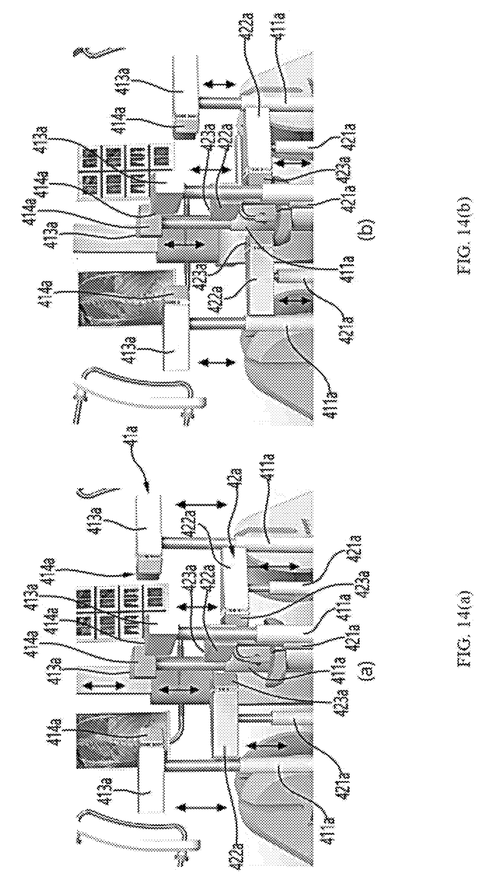

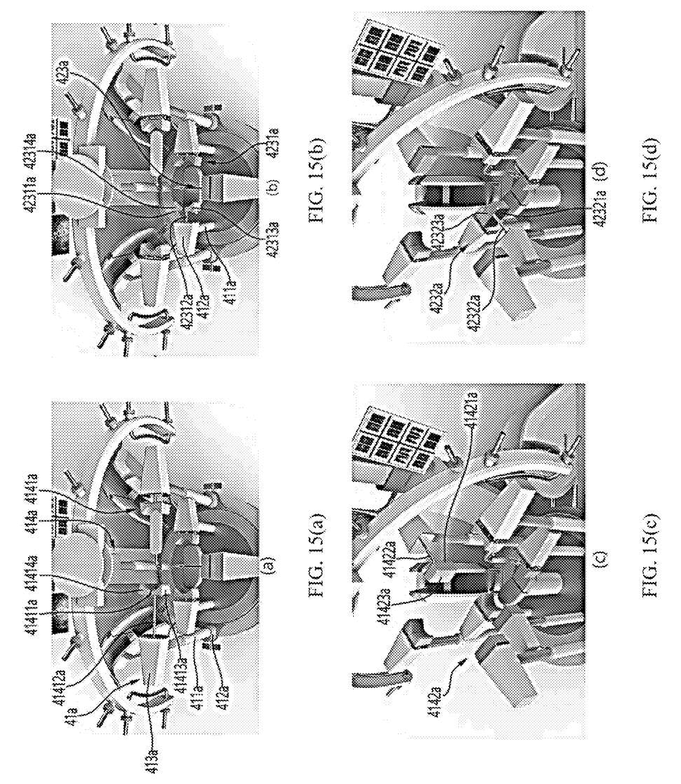

FIG. 14 is a view illustrating a vertical operation of the torso support part of the CKC spinal rehabilitation exercise device according to another embodiment of the present invention. FIG. 15 is a view illustrating a horizontal operation of the torso support part of the CKC spinal rehabilitation exercise device according to another embodiment of the present invention.

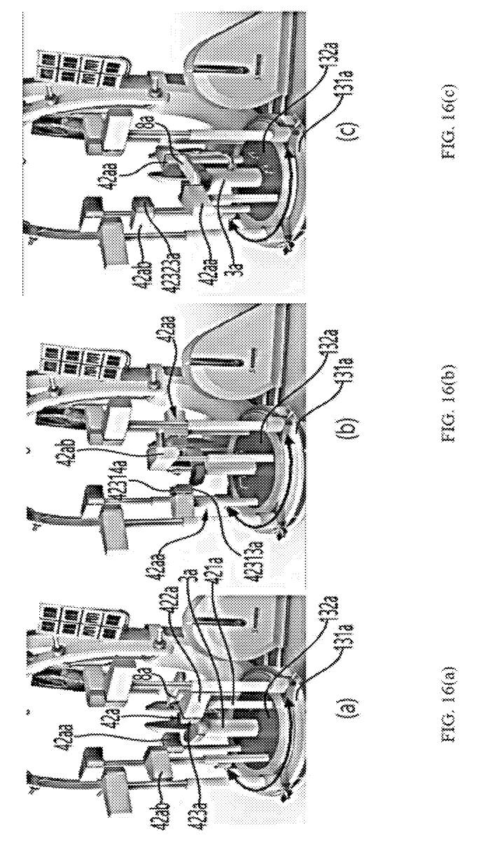

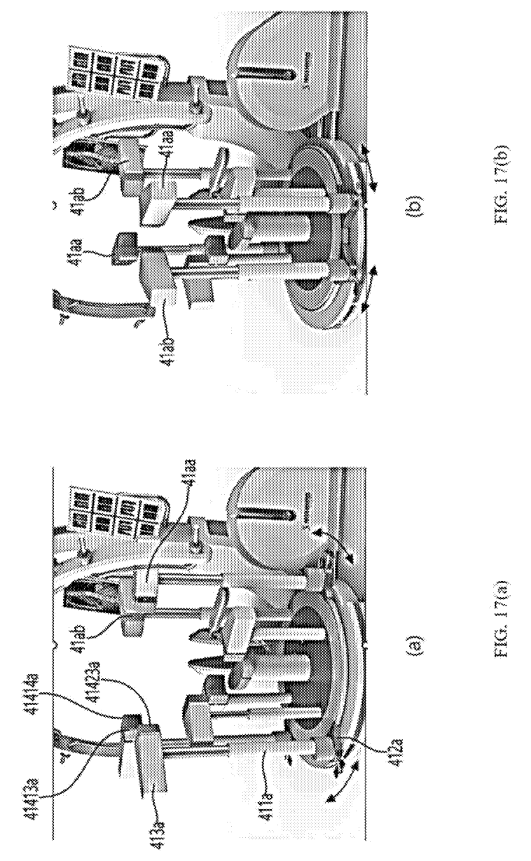

FIG. 16 is a view illustrating a rotating operation of a torso lower support part of the CKC spinal rehabilitation exercise device according to another embodiment of the present invention. FIG. 17 is a view illustrating a rotating operation of a torso upper support part of the CKC spinal rehabilitation exercise device according to another embodiment of the present invention.

Specifically, FIG. 14A illustrates one vertical movement of the torso support part, and FIG. 14B illustrates another vertical movement of the torso support part. In addition, FIG. 15A illustrates a horizontal movement of torso upper side support parts, FIG. 15B illustrates a horizontal movement of torso lower side support parts, FIG. 15C illustrates a horizontal movement of torso upper front and rear support parts, and FIG. 15D illustrates a horizontal movement of torso lower rear support parts.

In addition, FIG. 16A illustrates one example in which the torso lower support part rotates according to rotation of a torso upper foundation part, FIG. 16B illustrates another example in which the torso lower support part rotates according to rotation of the torso upper foundation part, and FIG. 16C illustrates still another example in which the torso lower support part rotates according to rotation of the torso upper foundation part.

Further, FIG. 17A illustrates one example in which the torso upper support part rotates on an upper side of a torso lower foundation part along the circumference of the torso upper foundation part, and FIG. 17B illustrates another example in which the torso upper support part rotates on the upper side of the torso lower foundation part along the circumference of the torso upper foundation part.

Referring to FIGS. 14 to 17, the torso foundation part 13a may include a torso lower foundation part 131a and a torso upper foundation part 132a. The torso lower foundation part 131a may be connected to the main body frame part 11a and may be seated on the floor. That is, the torso lower foundation part 131a may be fixed to the floor and may stably maintain the position of the main body frame part 11a. In addition, the torso lower foundation part 131a may be connected to the foot support parts 5a and may allow the foot support parts 5a to stably perform their functions.

The torso upper foundation part 132a may be disposed on an upper side of the torso lower foundation part 131a and may be provided to be rotatable. That is, the torso upper foundation part 132a may have a shape that corresponds to the torso lower foundation part 131a and a smaller cross-sectional area than the torso lower foundation part 131a, may be disposed on an upper portion of the torso lower foundation part 131a, and may be provided to be rotatable.

In addition, the torso upper foundation part 132a may provide a space in which a torso lower support part 42a, the pelvic correction part 3a, and the knee support parts 8a are disposed and may rotate these components by rotating.

That is, the torso upper foundation part 132a may be designed to have a structure that is rotatable up to 60°, and the torso lower support part 42a, the pelvic correction part 3a, and the knee support parts 8a, which are major support devices necessary for a rehabilitation exercise, may be integrally disposed thereon. Accordingly, the user can smoothly perform a rehabilitation exercise corresponding to his or her body condition.

Meanwhile, the torso support part 4a may include a torso upper support part 41a and the torso lower support part 42a. The torso upper support part 41a may be disposed on the upper side of the torso lower foundation part 131a and may be provided to be rotatable along a circumference of the torso upper foundation part 132a.

That is, the torso upper support part 41a may support a relatively higher side of the user’s body than the torso lower support part 42a to provide a pressure or support force necessary for a rehabilitation exercise and may be able to rotate independently from the torso upper foundation part 132a to enable the user to perform a complex rehabilitation exercise.

Specifically, the torso upper support part 41a may be height-adjustable within 1 m to 1.4 m based on the torso foundation part 13a, may support and fix the user’s torso in the front-rear and left-right directions, and may provide a predetermined pressure. That is, the torso upper support part 41a may stably support the entire torso of the user and may provide complex rehabilitation exercise courses.

The torso lower support part 42a may be disposed at the torso upper foundation part 132a and may be rotatable according to rotation of the torso upper foundation part 132a. That is, the torso lower support part 42a may be fixed to an upper side of the torso upper foundation part 132a and may move together along with movement of the torso upper foundation part 132a.

In addition, the torso lower support part 42a may be height-adjustable within 0.4 m to 0.7 m based on the torso foundation part 13a, may support and fix the rear side and the left and right sides of the user’s torso, and may provide a predetermined pressure. That is, the torso lower support part 42a may stably support most of the user’s torso and may provide complex rehabilitation exercise courses.

The torso lower support part 42a and the torso upper support part 41a may together provide a support force and pressing force at different heights and different positions to stably support the entire torso of the user and provide complex rehabilitation exercise courses.

Meanwhile, the torso upper support part 41a may include an upper support main body part 411a, an upper support rotating part 412a, an upper support moving part 413a, and an upper support pressing part 414a. The upper support main body part 411a may form an exterior. That is, the upper support main body part 411a may form the frame and may be disposed on the torso lower foundation part 131a.

The upper support rotating part 412a may connect the upper support main body part 411a and the torso upper foundation part 132a and may rotate independently from the rotation of the torso upper foundation part 132a. That is, the upper support rotating part 412a may rotate independently from the torso upper foundation part 132a along a path formed along the circumference of the torso upper foundation part 132a and may provide various complex rehabilitation exercise courses to the user.

The upper support moving part 413a may be connected to the upper support main body part 411a and may be provided to be movable in the up-down direction. That is, the upper support moving part 413a may have one end inserted into the upper support main body part 411a and the other end exposed to the outside to be height-adjustable according to movement inside the upper support main body part 411a. Accordingly, the position of the upper support moving part 413a may be adjusted in the vertical direction to fit the body structure of the user or move to the part of the user’s body where support is necessary or stimulation is necessary.

The upper support pressing part 414a may be disposed on an end of the upper support moving part 413a and may be provided to approach or move away from the pelvic correction part 3a. That is, the upper support pressing part 414a may be height-adjustable by the upper support moving part 413a, may be movable to approach or move away from the torso of the user seated on the pelvic correction part 3a, and may support the user’s body or provide pressure thereto to allow the user to efficiently perform a spinal rehabilitation exercise.

Meanwhile, the torso lower support part 42a may include a lower support main body part 421a, a lower support moving part 422a, and a lower support pressing part 423a. The lower support main body part 421a may form an exterior and may be seated on the torso upper foundation part 132a. That is, the lower support main body part 421a may be fixed on the torso upper foundation part 132a and may rotate together along with rotation of the torso upper foundation part 132a.

The lower support moving part 422a may be connected to the lower support main body part 421a and may be provided to be movable in the up-down direction. That is, the lower support moving part 422a may have one end inserted into the lower support main body part 421a and the other end exposed to the outside to be height-adjustable according to movement inside the lower support main body part 421a. Accordingly, the position of the lower support moving part 422a may be adjusted in the vertical direction to fit the body structure of the user or move to the part of the user’s body where support is necessary or stimulation is necessary.

The lower support pressing part 423a may be disposed on an end of the lower support moving part 422a and may be provided to approach or move away from the pelvic correction part 3a. That is, the lower support pressing part 423a may be height-adjustable by the lower support moving part 422a, may be movable to approach or move away from the torso of the user seated on the pelvic correction part 3a, and may support the user’s body or provide pressure thereto to allow the user to efficiently perform a spinal rehabilitation exercise.

In addition, the upper support pressing part 414a and the lower support pressing part 423a may operate together or operate independently as necessary to provide an efficient exercise effect customized for a rehabilitation program of the user.

Meanwhile, the torso upper support part 41a may include torso upper front and rear support parts 41aa and torso upper side support parts 41ab. The torso upper front and rear support parts 41aa and the torso upper side support parts 41ab may each include the upper support main body part 411a, the upper support rotating part 412a, the upper support moving part 413a, and the upper support pressing part 414a.

The torso upper front and rear support parts 41aa may be disposed at a front and rear of the torso lower foundation part 131a. That is, the torso upper front and rear support parts 41aa may be disposed at the torso lower foundation part 131a to support or press the front and rear of the user’s torso.

The torso upper side support parts 41ab may be disposed on both sides of the torso lower foundation part 131a and may be disposed apart from the torso upper front and rear support parts 41aa. That is, the torso upper side support parts 41ab may be disposed at the torso lower foundation part 131a to support or press both side surfaces of the user’s torso. That is, the torso upper front and rear support parts 41aa and the torso upper side support parts 41ab may be alternately disposed to support the user’s body in various ways and allow the user to smoothly perform a rehabilitation exercise.

Meanwhile, the torso lower support part 42a may include torso lower rear support parts 42aa and torso lower side support parts 42ab. The torso lower rear support parts 42aa and the torso lower side support parts 42ab may each include the lower support main body part 421a, the lower support moving part 422a, and the lower support pressing part 423a.

The torso lower rear support parts 42aa may be disposed at a rear of the torso upper foundation part 132a and may be disposed to face the knee support parts 8a. That is, the torso lower rear support parts 42aa may support or press the rear side of the user’s torso.

In addition, since the torso lower rear support parts 42aa are disposed on the opposite sides from the knee support parts 8a based on the pelvic correction part 3a and are not provided on the front where the knee support parts 8a are disposed, space efficiency of the entire device can be maximized.

The torso lower side support parts 42ab may be disposed on both sides of the torso upper foundation part 132a and may be disposed apart from the torso lower rear support parts 42aa. That is, the torso lower side support parts 42ab may be disposed at the torso upper foundation part 132a to support or press both side surfaces of the user’s torso. That is, the torso lower rear support parts 42aa and the torso lower side support parts 42ab may be alternately disposed to support the user’s body in various ways and allow the user to smoothly perform a rehabilitation exercise.

Meanwhile, the upper support pressing part 414a of each of the torso upper side support parts 41ab may be formed to be more curved than the upper support pressing part 414a of each of the torso upper front and rear support parts 41aa. That is, the upper support pressing part 414a of each of the torso upper side support parts 41ab may be formed to be curved to fit the shape of the user’s torso and allow the user to smoothly perform a rehabilitation exercise.

The lower support pressing part 423a of each of the torso lower side support parts 42ab may be formed to be more curved than the lower support pressing part 423a of each of the torso lower rear support parts 42aa. That is, the lower support pressing part 423a of each of the torso lower side support parts 42ab may be formed to be curved to fit the shape of the user’s torso and allow the user to smoothly perform a rehabilitation exercise.

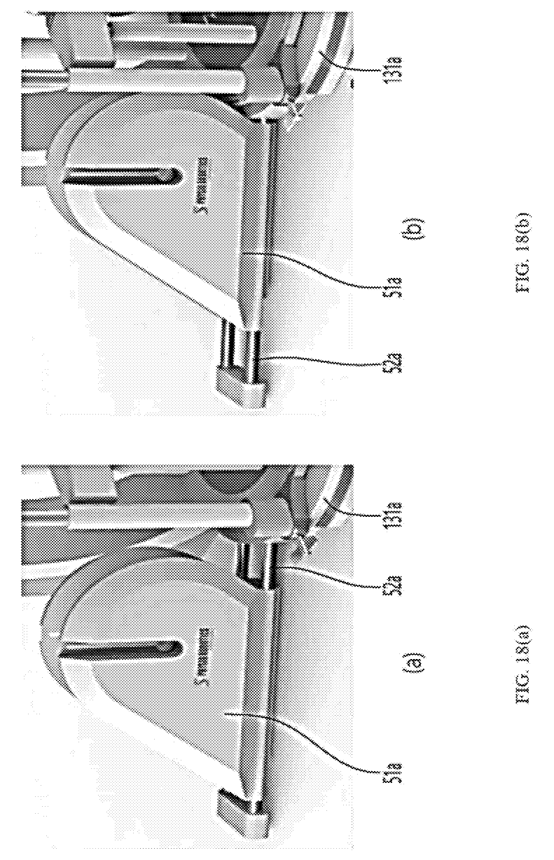

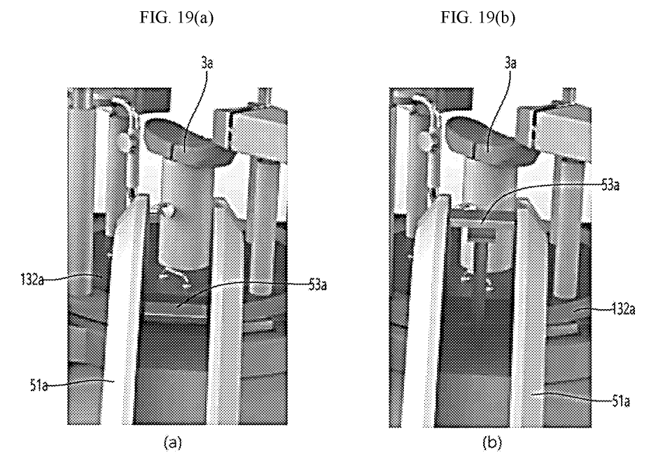

FIG. 18 is a view illustrating a horizontal operation of the foot support part of the CKC spinal rehabilitation exercise device according to another embodiment of the present invention. FIG. 19 is a view illustrating a vertical operation of the foot support part of the CKC spinal rehabilitation exercise device according to another embodiment of the present invention.

Specifically, FIG. 18A illustrates a horizontal operation of the foot support part at a first position, and FIG. 18B illustrates a horizontal operation of the foot support part at a second position different from the first position.

In addition, FIG. 19A illustrates a vertical operation of the foot support part at a first position, and FIG. 19B illustrates a vertical operation of the foot support part at a second position different from the first position.

Referring to FIGS. 18 and 19, the foot support parts 5a may each include a foot support main body part 51a, a foot support path part 52a, and a foot support placing part 53a. The foot support main body part 51a may form an exterior. That is, the foot support main body part 51a may form an exterior, may be connected to the main body part 1a, and may allow one foot of the user to be placed thereon to stably support the user’s foot.

The foot support path part 52a may be connected to the torso lower foundation part 141a and may provide a path along which the foot support main body part 51a is moved. That is, the foot support path part 52a may provide a path along which the foot support main body part 51a approaches or moves away from the pelvic correction part 3a. Accordingly, a rehabilitation effect can be maximized by the user adjusting the position of the foot support main body part 51a to be suitable for the user’s body or smoothly moving the user’s body during a rehabilitation exercise.

The foot support placing part 53a may be disposed on an inner side of the foot support main body part 51a and may be provided to be movable in the up-down direction. That is, the foot support placing part 53a can derive an optimum rehabilitation effect suitable for the user’s body by moving in the vertical direction to allow a rehabilitation exercise program to be performed by adjusting the position of the user’s foot.

The foot support part 5a is height-adjustable up to 0.2 m through the foot support placing part 53a according to the body conditions of a patient, a spinal rehabilitation exercise program suitable for the user can be provided through the vertical movement of the foot support placing part 53a and the horizontal movement of the foot support main body part 51a through the foot support path part 52a, and joint mobility of the user can be improved.

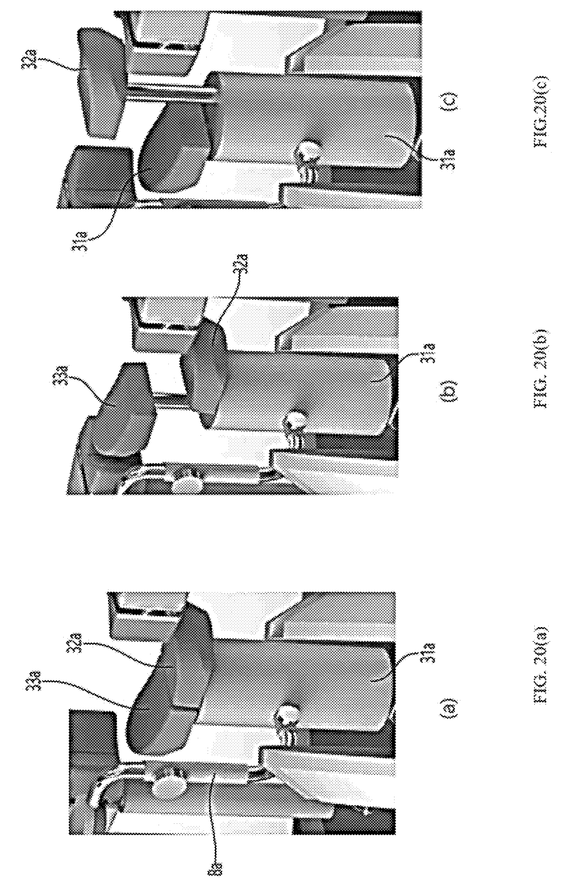

FIG. 20 is a view illustrating an operation of the pelvic correction part of the CKC spinal rehabilitation exercise device according to another embodiment of the present invention. Specifically, FIG. 20A illustrates the pelvic correction part before operation, FIG. 20B illustrates one operation of the pelvic correction part, and FIG. 20C illustrates another operation of the pelvic correction part.

Referring to FIG. 20, the pelvic correction part 3a may include a pelvic correction connecting part 31a, a pelvic one side placing part 32a, and a pelvic other side placing part 33a. The pelvic correction connecting part 31a may be placed on the torso foundation part 13a. That is, the pelvic correction connecting part 31a may be provided to have a predetermined length in consideration of the sitting height of the user and may be disposed on the torso foundation part 13a.

The pelvic one side placing part 32a may be provided on the pelvic correction connecting part 31a, and one side of the pelvis of the user may be placed on the pelvic one side placing part 32a. That is, if the pelvis of the user is distinguished as a left pelvis and a right pelvis, one of the left pelvis and the right pelvis of the user may be placed on the pelvic one side placing part 32a.

The pelvic other side placing part 33a may be disposed apart from the pelvic one side placing part 32a on the pelvic correction connecting part 31a, and the other side of the pelvis of the user may be placed on the pelvic other side placing part 33a. That is, if the pelvis of the user is distinguished as a left pelvis and a right pelvis, the pelvis that is not placed on the pelvic one side placing part 32a may be placed on the pelvic other side placing part 33a. In addition, the pelvic other side placing part 33a may be disposed a predetermined distance apart from the pelvic one side placing part 32a to prevent interference therebetween during movement in the vertical direction.

The pelvic one side placing part 32a and the pelvic other side placing part 33a may each be independently height-adjustable within 0.4 m to 0.6 m from the pelvic correction connecting part 31a. Accordingly, the pelvic correction part 3a may allow the user to effectively perform a spinal rehabilitation exercise by adjusting the position of the pelvis of the user and applying a predetermined pressure to the pelvis.

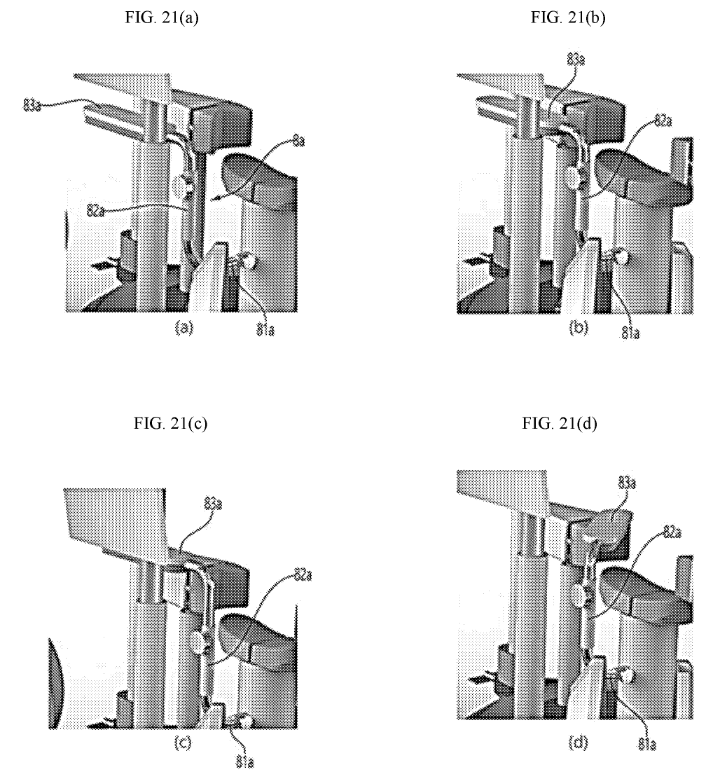

FIG. 21 is a view illustrating an operation of the knee support part of the CKC spinal rehabilitation exercise device according to another embodiment of the present invention. Specifically, FIG. 21A illustrates a state in which the knee support part is disposed at its original position, FIG. 21B illustrates a state in which the knee support part is moved forward, FIG. 21C illustrates a state in which the knee support part is moved rearward, and FIG. 21D illustrates a state in which the knee support part is rotated.

Referring to FIG. 21, the knee support parts 8a may each include a knee support moving part 81a, a knee support main body part 82a, and a knee support performing part 83a. The knee support moving part 81a may be connected to the pelvic correction part 3a and may be provided to be movable forward and rearward.

That is, the knee support moving part 81a may be provided to adjust the positions of the knee support main body part 82a and the knee support performing part 83a in the front-rear direction. Accordingly, the position of the knee support moving part 81a may be adjusted in consideration of the body structure of the user to allow the user to efficiently perform a rehabilitation exercise.

The knee support main body part 82a may have one end coupled to an end of the knee support moving part 81a. That is, the knee support main body part 82a may be coupled to the knee support moving part 81a and may move along with movement of the knee support moving part 81a. In addition, the knee support main body part 82a may be provided to have a predetermined height to allow one knee of the user to be supported.

The knee support performing part 83a may be coupled to the other end of the knee support main body part 82a, may be movable in the up-down direction, and may be provided to be pivotable to support the knee of the user. That is, the knee support performing part 83a may come into contact with the knee of the user and may provide a force supporting the knee when the user performs a rehabilitation exercise.

In addition, the knee support performing part 83a may be provided to be movable in all of the upward, downward, leftward, and rightward directions, and the position of the knee support performing part 83a may be adjusted to fit the body structure of the user. Accordingly, the knee support performing part 83a may allow the user to perform an optimum rehabilitation exercise.

Meanwhile, the monitor part 6a may include a first monitor part 61a and a second monitor part 62a. The first monitor part 61a may be provided on one side of the main body frame part 11a to provide first information. The first information is input patient information and may be information obtained by automatic diagnosis of the current state based on image data and other biometric signals.

That is, the first information may be information for automatically prescribing a patient an optimized customized exercise program based on a diagnostic result. In addition, the first information may be an exercise video provided in stages for a patient to easily follow.

The second monitor part 62a may be provided on the other side of the main body frame part 11a to provide second information. The second information may be muscle activity data (electromyography (EMG)) collected in real time and integrated image information collected through a plurality of cameras C. In addition, the second information may be information providing visual feedback based on the integrated image information. Accordingly, the user can recognize an accurate posture and can learn an accurate exercise pattern.

In addition, the second information may include information on whether a movement is correctly performed and information for correcting a wrong movement. Accordingly, the user can perform a rehabilitation exercise more accurately and efficiently.

Meanwhile, the upper support pressing part 414a may include upper support side pressing parts 4141a and upper support front and rear pressing parts 4142a. The upper support side pressing parts 4141a may be disposed on the torso upper side support parts 41ab, and the upper support front and rear pressing parts 4142a may be disposed on the torso upper front and rear support parts 41aa.

In addition, as described above, the upper support side pressing parts 4141a and the upper support front and rear pressing parts 4142a may be formed to have shapes that are partially different to provide an optimum rehabilitation exercise program to the user.

Specifically, the upper support side pressing parts 4141a may each include an upper side main body part 41411a, an upper side connecting part 41412a, an upper side one side part 41413a, and an upper side other side part 41414a. The upper side main body part 41411a may form an exterior.

The upper side connecting part 41412a may connect the upper side main body part 41411a and the upper support moving part 413a. In addition, the position of the upper side connecting part 41412a may be adjusted so that the upper side main body part 41411a moves from the upper support moving part 413a in the horizontal direction.

The upper side one side part 41413a may be disposed on one side of the upper side main body part 41411a, and the upper side other side part 41414a may be disposed on the other side of the upper side main body part 41411a. In addition, the upper side one side part 41413a and the upper side other side part 41414a may move independently from each other to effectively support the user’s torso and effectively press the user’s torso according to a rehabilitation exercise.

Meanwhile, the upper support front and rear pressing parts 4142a may each include an upper front-rear main body part 41421a, an upper front-rear connecting part 41422a, and an upper front-rear performing part 41423a. The upper front-rear main body part 41421a may form an exterior. The upper front-rear connecting part 41422a may connect the upper front-rear main body part 41421a and the upper support moving part 413a. In addition, the position of the upper front-rear connecting part 41422a may be adjusted so that the upper front-rear main body part 41421a moves from the upper support moving part 413a in the horizontal direction.

The upper front-rear performing part 41423a may be disposed on the upper front-rear main body part 41421a and may be provided to be rotatable. That is, the upper front-rear performing part 41423a may approach or move away from the user according to movement of the upper front-rear connecting part 41422a and may rotate as necessary to provide an optimum rehabilitation exercise program to the user.

Meanwhile, the lower support pressing part 423a may include lower support side pressing parts 4231a and lower support rear pressing parts 4232a. The lower support side pressing parts 4231a may be disposed on the torso lower side support parts 42ab, and the lower support rear pressing parts 4232a may be disposed on the torso lower rear support parts 42aa.

In addition, as described above, the lower support side pressing parts 4231a and the lower support rear pressing parts 4232a may be formed to have shapes that are partially different to provide an optimum rehabilitation exercise program to the user.

Specifically, the lower support side pressing parts 4231a may each include a lower side main body part 42311a, a lower side connecting part 42312a, a lower side one side part 42313a, and a lower side other side part 42314a. The lower side main body part 42311a may form an exterior.

The lower side connecting part 42312a may connect the lower side main body part 42311a and the lower support moving part 422a. In addition, the position of the lower side connecting part 42312a may be adjusted so that the lower side main body part 42311a moves from the lower support moving part 422a in the horizontal direction.

The lower side one side part 42313a may be disposed on one side of the lower side main body part 42311a, and the lower side other side part 42314a may be disposed on the other side of the lower side main body part 42311a. In addition, the lower side one side part 42313a and the lower side other side part 42314a may move independently from each other to effectively support the user’s torso and effectively press the user’s torso according to a rehabilitation exercise.

Meanwhile, the lower support rear pressing parts 4232a may each include a lower rear main body part 42321a, a lower rear connecting part 42322a, and a lower rear performing part 42323a. The lower rear main body part 42321a may form an exterior. The lower rear connecting part 42322a may connect the lower rear main body part 42321a and the lower support moving part 422a. In addition, the position of the lower rear connecting part 42322a may be adjusted so that the lower rear main body part 42321a moves from the lower support moving part 422a in the horizontal direction.

The lower rear performing part 42323a may be disposed on the lower rear main body part 42321a and may be provided to be rotatable. That is, the lower rear performing part 42323a may approach or move away from the user according to movement of the lower rear connecting part 42322a and may rotate as necessary to provide an optimum rehabilitation exercise program to the user.

As described above, the upper side one side part 41413a and the upper side other side part 41414a may be provided to be rotatable to approach or move away from each other, and the lower side one side part 42313a and the lower side other side part 42314a may be provided to be rotatable to approach or move away from each other. Accordingly, the user is allowed to perform an optimum rehabilitation exercise program.

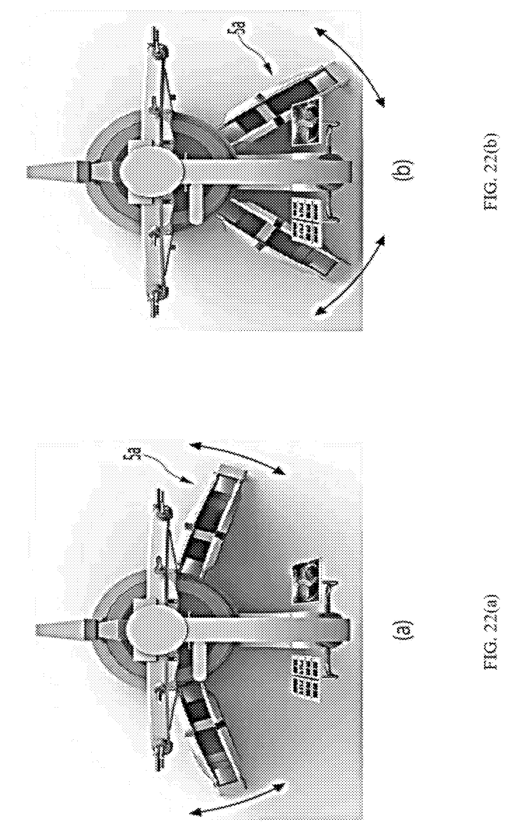

FIG. 22 is a view illustrating a rotating operation of the foot support parts of the CKC spinal rehabilitation exercise device according to another embodiment of the present invention. Specifically, FIG. 22A illustrates rotation of the foot support parts at a first position, and FIG. 22B illustrates rotation of the foot support parts at a second position different from the first position.

Referring to FIG. 22, the foot support parts 5a may rotate along the torso lower foundation part 131a. That is, the foot support parts 5a may rotate to fit the body structure of the user and the positions of the foot support parts 5a may be adjusted, or the foot support parts 5a may apply a predetermined force to the user or adjust the body structure of the user when the user is performing a rehabilitation exercise program, thereby allowing the user to smoothly perform a rehabilitation exercise.

In another embodiment, the exercise device S of the present invention may further include a load detection sensor that detects a load during up-down driving of the pelvic correction part 3a, the torso support part 4a, and the foot support parts 5a.

According to an embodiment of the present invention, scoliosis correction can be performed by a pushing force or a pulling force being imparted to a spinal region when a user grips a handle part by hand and pulls the handle part in a state in which the user is seated on a spinal correction part and the lower body of the user is fixed. In particular, in an embodiment of the present invention, for the pushing force or the pulling force to be further imparted to a region where the degree of curvature of the spine is severe compared to a normal state among both sides of the spinal region of the user, the handle part may be configured to be movable along an extension part and configured to be rotatable relative to the extension part in the state in which the user is seated on the spinal correction part, and the position of the handle part relative to the spinal region of the user can be easily adjusted. Accordingly, by the pushing force or the pulling force being further imparted to the region where the degree of curvature of the spine is severe compared to the normal state among both sides of the spinal region of the user, the scoliosis correction effect can be further maximized. That is, by a spinal rehabilitation exercise device of the present invention providing various driving patterns for strengthening the spine of the user, correction optimized for different body types and spinal conditions of spinal patients can be easily performed.

Embodiments of the present invention can provide a CKC rehabilitation exercise device that allows support positions of the arms, torso, pelvis, knees, and feet to be independently adjusted according to the body type and rehabilitation stage of a user.

Embodiments of the present invention can provide a CKC rehabilitation exercise device that can induce organic movement of the trunk and limbs while fixing the hands and feet according to a CKC exercise method.

Embodiments of the present invention can provide a CKC rehabilitation exercise device that can implement various postures by each support part being movable in various directions such as an up-down direction, a front-rear direction, and a rotating direction.

Embodiments of the present invention can provide a CKC rehabilitation exercise device that can provide user-centered feedback by providing exercise information and a state of the body through a plurality of monitors in real time.

Embodiments of the present invention can provide a CKC rehabilitation exercise device that can improve precision and convenience of a rehabilitation exercise by coupling a power part to each support part and automatically or semi-automatically adjusting a posture.

Various other additional effects can be achieved by various embodiments of the present invention. Various effects of the present invention have been described above in detail in each embodiment, and description of effects that can be easily understood by those of ordinary skill in the art has been omitted.

While the present invention has been described above using limited embodiments and drawings, the present invention is not limited thereby, and of course, various modifications and changes may be made by those of ordinary skill in the art to which the present invention pertains within the scope equivalent to the technical idea of the present invention and the claims set forth below.

Meanwhile, although terms indicating directions such as up, down, left, right, front, and rear have been used in the present invention, such terms are only for convenience of description, and it is apparent to those of ordinary skill in the art of the present invention that the terms may be changed according to the position of a target object, the position of an observer, or the like.

What is claimed is:

1. A spinal rehabilitation exercise device comprising:
a body;
an extension part configured to extend from the body;
a handle part provided on the extension part and configured to move along the extension part or rotate relative to the extension part according to manipulation by a user; and
a spinal correction part provided on the body and configured to press a spinal region of the user while the user is seated thereon.

2. The spinal rehabilitation exercise device of claim 1, wherein the extension part is configured to be pivoted at a predetermined angle relative to the body.

3. The spinal rehabilitation exercise device of claim 1, wherein the extension part includes:
a front extension part located on a front side of the spinal correction part; and
a pair of side extension parts located on both sides of the spinal correction part, and
when viewed on a horizontal plane, an angle that the pair of side extension parts form based on an area where the front extension part is located is less than 180°.

4. The spinal rehabilitation exercise device of claim 1, wherein the handle part includes:
a first handle located on the extension part and on the front side of the spinal correction part; and
second handles located on the extension part and on both sides of the spinal correction part,
wherein the first handle is configured to move along the extension part located on the front side of the spinal correction part or rotate relative to the extension part due to manipulation by the user while the user is seated on the spinal correction part, and
the second handles are configured to move along the extension parts located on both sides of the spinal correction part or rotate relative to the extension parts due to manipulation by the user while the user is seated on the spinal correction part.

5. The spinal rehabilitation exercise device of claim 1, wherein the spinal correction part includes:
a seating part that is position-changeable in an up-down direction and configured to rotate relative to the body through a base part; and
a pelvic fixation part provided on the seating part and configured to fix the pelvis of the user.

6. The spinal rehabilitation exercise device of claim 5, wherein the spinal correction part further includes first spine pressing parts disposed on both sides of the spinal region of the user and configured to press both sides of the spinal region of the user.

7. The spinal rehabilitation exercise device of claim 6, wherein the first spine pressing parts each include:
a first pressing driving part configured to be driven toward a side surface of the spinal region of the user and press the side surface of the spinal region of the user; and
a first up-down driving part configured to change a position of the first pressing driving part in an up-down direction and configured to rotate along the base part.

8. The spinal rehabilitation exercise device of claim 5, wherein the spinal correction part further includes a second spine pressing part disposed on a rear surface of the spinal region of the user and configured to press the rear surface of the spinal region of the user.

9. The spinal rehabilitation exercise device of claim 8, wherein the second spine pressing part includes:
a second pressing driving part configured to be driven toward the rear surface of the spinal region of the user and press the rear surface of the spinal region of the user; and
a second up-down driving part configured to change a position of the second pressing driving part in the up-down direction.

10. A closed kinetic chain (CKC) spinal rehabilitation exercise device comprising:
a main body part forming an exterior;
arm support parts connected to an upper side of the main body part and supporting the arms of a user;
a pelvic correction part provided on a lower side of the main body part and provided so that the user is able to sit thereon;
a torso support part disposed apart from the pelvic correction part on the main body part and provided to support the torso of the user;
foot support parts connected to the main body part, provided to be movable, and provided to support the feet of the user; and
a monitor part disposed apart from the torso support part on the main body part and provided to allow the user to check body information.

11. The CKC spinal rehabilitation exercise device of claim 10, further comprising:
handle parts provided on the arm support parts and provided to be gripped by the user; and
knee support parts provided on the pelvic correction part to support the knees of the user,
wherein the main body part includes a torso foundation part that has an upper side on which the pelvic correction part and the torso support part are disposed and that is provided so that at least a portion thereof is rotatable.

12. The CKC spinal rehabilitation exercise device of claim 11, wherein:
the main body part is provided to be movable in an up-down direction;
the arm support parts are provided to be rotatable to move away from or approach the pelvic correction part;
the handle parts are provided to be movable to move away from or approach the pelvic correction part;
the torso support part is movable in the up-down direction and provided to be movable to move away from or approach the pelvic correction part; and
the foot support parts are movable to move away from or approach the pelvic correction part and have at least a portion provided to be movable in the up-down direction.

13. The CKC spinal rehabilitation exercise device of claim 12, wherein:
the main body part further includes a main body frame part forming an exterior and a main body moving part that is connected to the main body frame part, extends to be curved, and is provided to be movable in the up-down direction;
the arm support parts each include an arm support pivoting part connected to an end of the main body moving part and provided to be pivotable and an arm support main body part extending in a curved manner from the arm support pivoting part;
the handle parts each include an upper handle part provided on the arm support main body part, a lower handle part disposed apart from the upper handle part to be provided closer to the pelvic correction part than the upper handle part on the arm support main body part, an upper power part that connects the upper handle part and the arm support main body part and is provided to move the upper handle part, and a lower power part that connects the lower handle part and the arm support main body part and is provided to move the lower handle part;
the pelvic correction part includes a pelvic correction connecting part placed on the torso foundation part, a pelvic one side placing part provided on the pelvic correction connecting part and on which one side of the pelvis of the user is placed, and a pelvic other side placing part disposed apart from the pelvic one side placing part on the pelvic correction connecting part and on which the other side of the pelvis of the user is placed; and
the pelvic one side placing part and the pelvic other side placing part are provided to be independently movable in the up-down direction.

14. The CKC spinal rehabilitation exercise device of claim 13, wherein:
the torso foundation part includes a torso lower foundation part connected to the main body frame part and placed on a floor and a torso upper foundation part disposed on an upper side of the torso lower foundation part and provided to be rotatable;
the torso support part includes a torso upper support part disposed on the upper side of the torso lower foundation part and provided to be rotatable along a circumference of the torso upper foundation part and a torso lower support part that is disposed at the torso upper foundation part and rotatable according to rotation of the torso upper foundation part;
the torso upper support part includes an upper support main body part forming an exterior, an upper support rotating part that connects the upper support main body part and the torso upper foundation part and rotates independently from the rotation of the torso upper foundation part, an upper support moving part connected to the upper support main body part and provided to be movable in the up-down direction, and an upper support pressing part disposed on an end of the upper support moving part and provided to approach or move away from the pelvic correction part; and
the torso lower support part includes a lower support main body part forming an exterior and placed on the torso upper foundation part, a lower support moving part connected to the lower support main body part and provided to be movable in the up-down direction, and a lower support pressing part disposed on an end of the lower support moving part and provided to approach or move away from the pelvic correction part.

15. The CKC spinal rehabilitation exercise device of claim 14, wherein:
the torso upper support part includes torso upper front and rear support parts disposed at a front and rear of the torso lower foundation part and torso upper side support parts disposed on both sides of the torso lower foundation part and disposed apart from the torso upper front and rear support parts;
the torso lower support part includes torso lower rear support parts disposed at a rear of the torso upper foundation part and disposed to face the knee support parts and torso lower side support parts disposed on both sides of the torso upper foundation part and disposed apart from the torso lower rear support parts;
the upper support pressing part of each of the torso upper side support parts is formed to be more curved than the upper support pressing part of each of the torso upper front and rear support parts; and
the lower support pressing part of each of the torso lower side support parts is formed to be more curved than the lower support pressing part of each of the torso lower rear support parts.

16. The CKC spinal rehabilitation exercise device of claim 15, wherein the foot support parts each include:
a foot support main body part forming an exterior;
a foot support path part that is connected to the torso lower foundation part and provides a path along which the foot support main body part is moved; and
a foot support placing part disposed on an inner side of the foot support main body part and provided to be movable in the up-down direction.

17. The CKC spinal rehabilitation exercise device of claim 16, wherein the knee support parts each include:
a knee support moving part connected to the pelvic correction part and provided to be movable forward and rearward;
a knee support main body part having one end coupled to an end of the knee support moving part; and
a knee support performing part that is coupled to the other end of the knee support main body part, is movable in the up-down direction, and is provided to be pivotable to support a knee of the user.

18. The CKC spinal rehabilitation exercise device of claim 17, wherein the monitor part includes:
a first monitor part provided on one side of the main body frame part to provide first information; and
a second monitor part provided on the other side of the main body frame part to provide second information.
